(19) United States
(12) Patent Application Publication
(10) Pub. No.: US 2017/0364334 A1
(43) Pub. Date: Dec. 21, 2017

(54) Method and Apparatus of Read and Write for the Purpose of Computing

(71) Applicants: Atti Liu, San Jose, CA (US); Lei Liu, San Jose, CA (US)

(72) Inventors: Atti Liu, San Jose, CA (US); Lei Liu, San Jose, CA (US)

(21) Appl. No.: 15/187,779

(22) Filed: Jun. 21, 2016

(51) Int. Cl. G06F 9/44; G06F 17/28

(52) U.S. Cl. CPC G06F 8/311; G06F 17/28

(57) ABSTRACT

A method for read/write in a virtual or a sensing environment comprise receiving a request to read/write from the environment, determining a probe command associated with the request, building a system of symbols and operational rules to identify the language, recalling relevant instances with accuracy and measures, identifying invariants as patterns for associated form processing, enabling time-like or space-like read/write.

### BACKGROUND

One of challenging problems in computing is read and write. Read and write can he constructed based on analyzing projected two-dimensional images from the higher-dimensional world. Read and write can also be constructed based on analyzing information obtained through other sensing of touch and hearing. In both cases, read and write create flexible methods of spatial representation based on the information.

### SUMMARY

In general, in one aspect, the invention relates to a method for read/write in a virtual or a sensing environment comprise receiving a request to read/write from the environment, determining a probe command associated with the request, building a system of symbols and operational rules to identify the language, recalling relevant instances with accuracy and measures, identifying invariants as patterns for associated form processing, enabling time-like or space-like read/write.

Other aspects of the invention will be apparent from the following description and the appended claims.

### BRIEF DESCRIPTION OF DRAWINGS

FIGS. 1, 2, 3, and 4 show flowcharts in accordance with one embodiment of the invention.

FIG. 5 shows systems in accordance with one embodiment of the invention.

### DETAILED DESCRIPTION

(1) Exemplary embodiments of the invention will be described with reference to the accompanying drawings. Like items in the drawings are shown with the same reference numbers.

(2) In an embodiment of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

(3) In general, embodiments of the invention relate to a method and apparatus for read and write for computing. More specifically, embodiments of the invention enable read/write including information proceeded through a series of steps. This kind of read and write allows one to carry out long computations. The other kind of read and write allows one to read and write information all at once. The spatial read and write has less dependency with visualized experience than tactile ones.

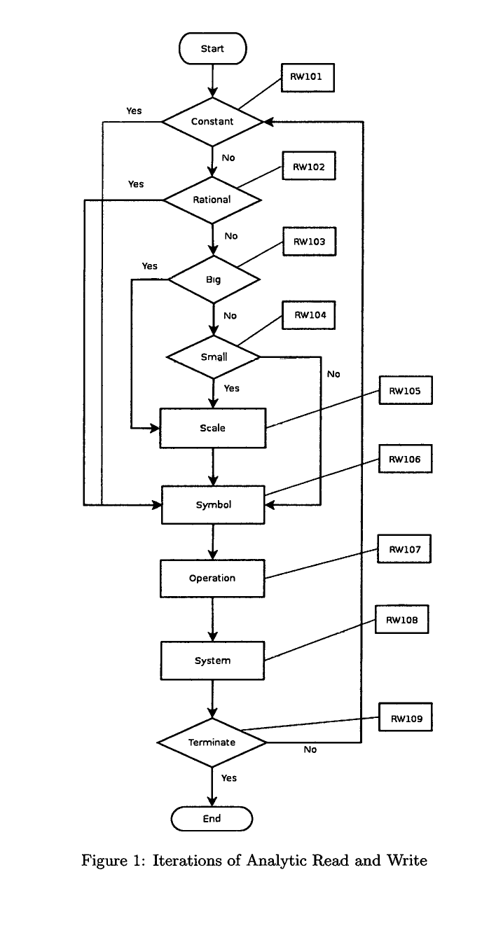

(4) FIG. 1 shows a flowchart in accordance with one embodiment of the invention. Initially, a request starts to read/write from a virtual space or a sensor. In one embodiment of the invention, a determination is made about whether the read/write is a constant (RW101). A constant is detected as an object or a structure which is special and significantly interesting in some way. If the request is to read/write a constant, then the constant will be symbolized (RW106).

(5) Symbolizing constants (RW106) makes the notation concise. Some constants have an analytic form which can be constructed using known operations for computing. Some constants do not have known analytic forms. Letters symbolize constants. For more important constants, the symbols may be more complex with an extra letter. Sometimes, a constant is represented as a symbol with a whole word.

(6) In one embodiment of the invention, a determination is made about whether the read/write is rational (RW102) if the request is not to read/write a constant. A rational is detected as an object or a structure whose expansion always either terminates after a finite number of representations or begins to infinitely repeat the same finite sequence of representations. Any repeating or terminating is detected as a rational. Without expansions, a rational can be instrumented as a dense subset or detected as equivalence classes of ordered pairs.

(7) In one embodiment of the invention, a determination is made about whether the read/write is big (RW103) when the expansion continues without repeating or the request does not satisfy the above criteria specified in (6). In common practice, when developing read/write, one considers a case involving all groups or all topological spaces . . . This case creates a problem from the point of view of set theory because this is an easy consequence of the well-known paradox: the set of sets does not exist. The collection of objects is too large to form a set. Generally speaking, one needs to avoid doing anything which is obvious illegal such as considering the “big of the big” as an object itself. Embodiments of the invention handles the large objects such as the collection of all groups, the collection of all sets, the collection of all topological spaces, and so on . . . Therefore, it is useful to pay some attention of these questions of size at the earlier stage of the invention in cases of the big read/write.

(8) In one embodiment of the invention, a device is developed to enable one to distinguish between big and small (RW104). (a) Constructing a sufficient supply of universes. (b) Constructing a framework which allows both sets and classes. (c) Working in a standard set-theoretic framework but incorporating a theory of classes through some ad hoc device. For example, this invention develops a class to be collection of sets which is defined by some formula in set theory.

(9) In one embodiment of the invention, the sizing problem (the big or the small) can also be handled by working exclusively with the small, and mirror the distinction between the big and the small by keeping careful track of the relative sizes. When one is experiencing the disadvantage of burdening the exposition with and additional layer of techniques, this invention uses the above specified device.

(10) In one embodiment of the invention, the sizing problem can be handled by ignoring the big. When one needs to make arguments which play off the distinction between the big and the small which is contained in the big and determines the big, this invention uses the above specified device.

(11) In one embodiment of the invention, the scale (RW105) is a standard form expressing the big or the small to be conveniently written in the form. In addition, this invention uses a significant figure that adds to the precision. This invention has a customary to record all the definitely known figures and at least one additional figure if there is any information to enable the observer's estimation. The result contains more information with the extra figures so that the figures may be considered to be significant because it conveys some information leading to greater precision in computing and in aggregations of computing. In one embodiment of the invention, additional information about precision can be conveyed through additional notations. It may be useful to know how exact the final figures are.

(12) In one embodiment of the invention, the scale can be a linear transformation. This includes the uniform scaling that enlarge or shrinks objects by the same factor in all directions. The results can he congruent or similar objects. The uniform scaling can have separate factor for each direction. Non-uniform scaling has at least one of the scaling factors is different from the others. Non-uniform scaling can change the shape of the object. In a generalized sense, the scaling includes the case in which the directions of scaling are not perpendicular. It also includes the projection case where one or more scale factors are equal to zero and the reflection case of one or more negative scale factors.

(13) In one embodiment of the invention, read/write will be symbolized after applying the above scaling device and transformation. Symbols (RW106) are organized by types. A related list of symbols are organized by topics and subjects into tables. That list also includes markup and unicode code points for each symbol. Some symbols are reserved for read/write. Some symbols are reserved in the order and sequence of writing. It is important to recognize that an object or a structure is independent of the symbol chosen to represent it.

(14) In one embodiment of the invention, an operation (RW107) is a function performed from zero or more inputs to an output. A function is called respectively a nullary, unitary, binary, ternary, n-ary operation in cases of different inputs. A nullary operation is a selection. An unitary operation is an identity, a negation, or a trigonometric function. Operations can involve any object other than numbers. Operations may not be defined for any possible object. The inputs and the outputs of a operations can involve different types of objects. An operation may or may not have certain properties or rules such as composition, associative, commutative, anticommutative, distributive, idempotent, and so on. An operation focuses on the inputs and output result where operators focuses on the process.

(15) In one embodiment of the invention, a system (RW108) aries from the above symbols and operational rules. Different types of symbols and operations have many different uses. This inventions classifies symbols and operations into sets, called systems.

(16) In one embodiment of the invention, a determination is made about whether the iterative read/write is terminated (RW109) by the end of computing. This is to determine, from an arbitrary read/write and an input, whether the read/write will finish running or continue to run forever. In another word, the problem is to determine, given a program and an input to the program, whether the program will eventually halt when run with that input. In one embodiment of the invention, there are no resource assumptions on the amount of memory or time required for the read/write execution. Read/write can take arbitrarily long, and use arbitrarily as much storage space, before halting. A read/write process terminates its execution by making an exit call. More generally, an exit means that an execution has stopped running. As the final step of termination, an exit call is invoked, informing that the process has terminated and allows it to reclaim the resources used by the read/write process. The read/write process is said to be a dead process after it terminates.

(17) Some read/write handles a child process whose parent process has terminated in a special manner. This invention handles an orphan process becomes a child of a special root process, which then waits for the child process to terminate. Similarly, this invention also handles a zombie process, which is a child process that has terminated but whose exit status is ignored by its parent process. Such a process becomes the child of a special parent process that retrieves the child's exit status. This allows the system to complete the termination of the dead process. This inventions develops a system read/write table in a consistent state. In case of the undecidable problem, this invention develops additional metrics, utilities, and goals to halt the iterations of read/write.

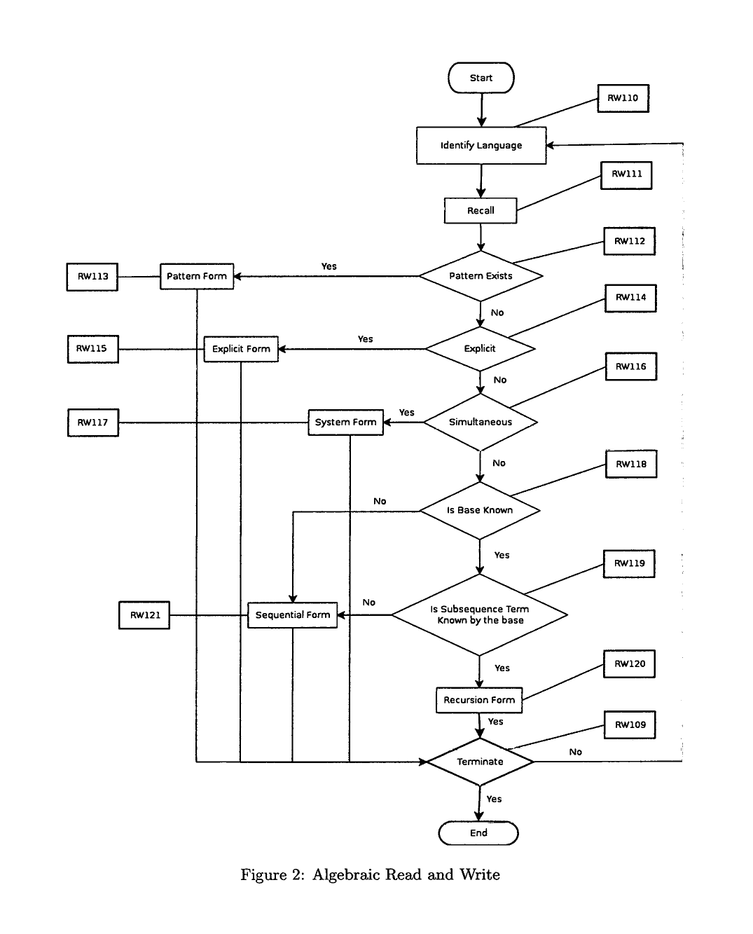

(18) FIG. 2 shows a flowchart in accordance with one embodiment of the invention. Initially, a request starts to read/write from a virtual space or a sensor. In one embodiment of the invention, read/write uses a language (RW110). The language is the system of symbols and operational rules developed by the analytic iterations of FIG. 1 to be commutative involved with substitutions and exchanges. This language consists of a substrate of some natural language supplemented by symbolic notations for formulas.

(19) In one embodiment of the invention, read/write recalls the theory and properties etc. The recall (RW111) is developed as binary classification to retrieve relevant instances. In one embodiment of the invention, the perfect recall score of 1.0 is specified when all relevant theories were retrieved. Recall is plotted as ROC curves. The application of recall may be flawed as they ignore the true negative cell of the contingency table. This invention combines recall and accuracy. Informedness and Markedness are Kappa-like renormalizations of recall. The recall has the geometric mean Matthews correlation coefficient thus acts like a debiased F-measure.

(20) In one embodiment of the invention, a determination is made about whether the recall identifies patterns (RW112) which are invariants. The recognition is developed to determine the equivalence of two objects or structures. The algorithms developed to solve this task can be extremely time-consuming. A major issue of understanding how hard this problem really is is developed in this invention. The special case of recognizing the standard forms or deformable objects or structures is of particular feature of this invention.

(21) In one embodiment of the invention, the pattern form (RW113) is invoked when the pattern is identified. This invention uses tools from abstract algebra, such as group theory, to investigate properties of spaces. The pattern form tells whether two spaces are the same by calculating algebraic invariants associated with spaces, which include its homotopy groups and homology and cohomology groups. Equivalent spaces have isomorphic homotopy/(co)homology groups. If two spaces have different groups, then they are not equivalent. Thus, the pattern form identifies these algebraic invariants which provide global information about a space. This complements the local information provided by notions such as continuity.

(22) In one embodiment of the invention, a determination is made about whether a explicit types, functions, and relations (RW114) are developed for the read/write. The explicit relation can be concrete formulas, posets and monotone functions, groups and group homomorphisms, vector spaces and linear mappings, graphs and graph homomorphisms, real numbers and continuous functions, topological spaces and continuous mappings, differential manifolds and smooth mappings, natural numbers and all recursive functions.

(23) In one embodiment of the invention, the explicit form (RW115) is invoked when the above explicit types, functions, and relations are identified. First, this invention chooses an object of C for each type in the theory. Then this invention chooses a morphism in C for each function symbol in the theory. And finally, we choose a subobject in C for each relation in the theory. By induction, this invention develops an interpretation of every term that can be constructed from the theory by a morphism in C. The by induction, this invention defines an interpretation of every logical formula that can be constructed from the theory by a subobject in C. This invention constructs the building blocks of logical formulas. This construction corresponds to operations on the posets Sub(A) of subobjects. This inventions interprets existential and universal quantifiers as left and right adjoints to pullbacks. The explicit form constructs a model of a given theory in C consisting of a choice of the above objects, morphisms, and subobjects for the types, function symbols, and relation symbols.

(24) In one embodiment of the invention, a determination is made about whether read/write contains simultaneous functions and relations (RW116). This invention constructs or up-dates a map of an unknown relations while simultaneously keeping track of read/write positions within it.

(25) In one embodiment of the invention, the system form (RW117) is invoked when the simultaneous functions and relations are identified. This representation of m equations jointly in vector form is developed as the structural form. Postmultiplying the structural equation, the system form can be written in the reduced form. This invention develops the structural form to model from deductive theories while reduced form models start from identifying particular relationships between variables. This invention develops topological maps as a method of environment representation capturing the connectivity. This is different from creating a geometrically accurate map. When the projection data is limited, this invention generates a good reconstruction in one iteration and it is better to standard algebraic reconstruction technique.

(26) In one embodiment of the invention, a determination is made about whether read/write is recursive which is given by the base (RW118) and the subsequent term derived from the base (RW119). This invention develops a class of objects exhibit recursions by a simple base case (or cases) which is a terminating scenario that does not use recursion to produce a solution and a set of rules that reduce all other cases toward the base case.

(27) In one embodiment of the invention, the recursion form (RW120) is invoked when the recursive behavior is identified. This invention develops the recursive form as the process of repeating items in a self-similar way. The recursive form is a method of defining functions and relations in which the function and relation being defined is applied within its own definition. Specifically, the recursion form defines an infinite number of function values with a finite expression because some function values may refer to other ones. The recursion form has no loop or infinite chain of references. This invention generalizes the recursion form to describe a process of repeating objects in a self-similar way.

(28) In one embodiment of the invention, every read/write can invoke the sequential form (RW121) when data examples where the values are delivered in a sequence. The sequential form takes the position of each item as the input.

(29) In one embodiment of the invention, a determination is made about whether read/write is terminated as specified in RW109.

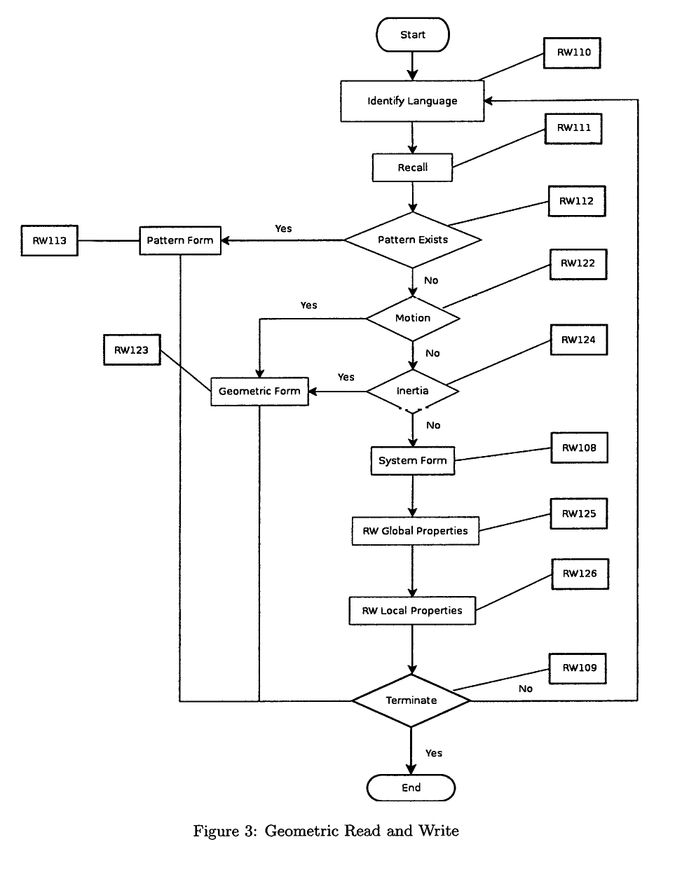

(30) FIG. 3 shows a flowchart in accordance with one embodiment of the invention. Initially, a request starts to read/write from a virtual space or a sensor. In one embodiment of the invention, read/write uses a language (RW110), recall (RW111), pattern exist determination (RW112), and pattern form (RW113) are specified in FIG. 2. In one embodiment of the invention, a determination is made about whether a motion (RW122) is detected. A motion preserves a metric such as distance. For instance, the Euclidean distance is a metric space in which a motion is a mapping between congruent figures. This invention develops both proper or rigid motions and inproper motions. Rigid motions are motions like translations and rotations that preserve the orientation. Inproper motions are motions like reflections, glide reflections. Improper rotations invert the orientation.

(31) In one embodiment of the invention, the geometric form (RW123) is invoked when a motion is detected. The geometric form constructs a trajectory of the motion of an object. This geometric form constructs the set of motions as a group under composition of mappings. The geometric form develops any motion as a one to one mapping of space onto itself. This invention forms motions as a group. In this invention, there is a motion that maps every line to every line. When there is a plane A, a line g, and a point P such that P is on g and g is on A, this geometric forms four motions mapping A, g and P onto themselves, respectively. There are not more than two of these motions having every point of g as a fixed point, while there is one of them for which every point of A is fixed. Given three points A, B, P on line g such that P is between A and B and for every point C between A and B, the geometric form gives a point D between C and P such that no motion with P as fixed point can be found which will map C onto a point between D and P.

(32) In one embodiment of the invention, a determination is made about whether read/write the inertia (RW124). This invention develops both classic inertia and inertia in terms of geodesic deviation. As the result, this invention detects inertia with very large scales. For sufficiently small regions, inertia works the same as in the classical model. This invention supports the new relations such that energy and mass are not separated but interchange able. In addition, this determination also concerns with the long term behavior of the solutions of dynamical systems. This invention detects finite-dimensional, smooth, and invariant manifolds that contain the global attractor and attract all solutions exponentially quickly.

(33) In one embodiment of the invention, the geometric form (RW123) is invoked when the inertia is detected. To simplify development, the geometric form analyzes the dynamics on an manifold. The geometric form develops numerical schemes to capture the long term dynamics by forming an approximate manifold. The geometric form derives the existence results such that manifolds that are expressible as a graph. This geometric form can ignore the motion of the object by defining it as a frame. In the frame, the uniform motion will observe the same laws. However, from outside the moving object this geometric form could deduce that the motion falls vertically downwards. In addition, the geometric form develops the property that a rotating rigid body preserves its state of uniform rotational motion.

(34) In one embodiment of the invention, the system form (RW108) is invoked as specified in FIG. 1. In one embodiment of the invention, the global properties (RW125) are developed. This invention develops continuity as global properties. This invention analyzes invariants including homotopy groups and homology and cohomology groups. These invariants provide global information complements the local information provided by notions such as continuity. This invention develops a method composing paths and also allows for the expression giving subdivision from the global properties to local properties (RW126). Compositions give global properties from local properties. This invention develops an abstract space in which every point has a neighborhood which resembles Euclidean space, but in which the global structure may be more complicated. This inventions develops the higher dimensional, nonabelian, local-to-global properties through algebraic inverses to subdivision. This inventions develops global invariants such as the center of mass of a finite set of points is invariant under any isometry.

(35) In one embodiment of the invention, problems of subdivisions, compositions of simplicies, Klein bottle diagram are resolved using groupoids and cubical developments in specific schemes. This invention develops commutative cubes in a double groupoid in which horizontal and vertical edges come from the same groupoid. The special squares with commutative boundaries is constructed by the laws of connections. This invention develops cubical groups with connections which are Kan complexes. This invention characterizes convex sets by various local convexity conditions. The specific case passes from local to global properties. This invention develops a great number of infinitesimal similarities with are not global similarities. For example, inversions and compositions of inversions are not global similarities.

(36) In one embodiment of the invention, objects are developed as functors. A local view of “locales” in the object are also developed from global views. This invention develops the germ of an object is an equivalence class which captures their shared local properties. The objects are mostly functions and subsets. This invention has the specific implementation, the sets or functions have some properties such as being analytic or smooth.

(37) In one embodiment of the invention, a determination is made about whether read/write is terminated as specified in RW109.

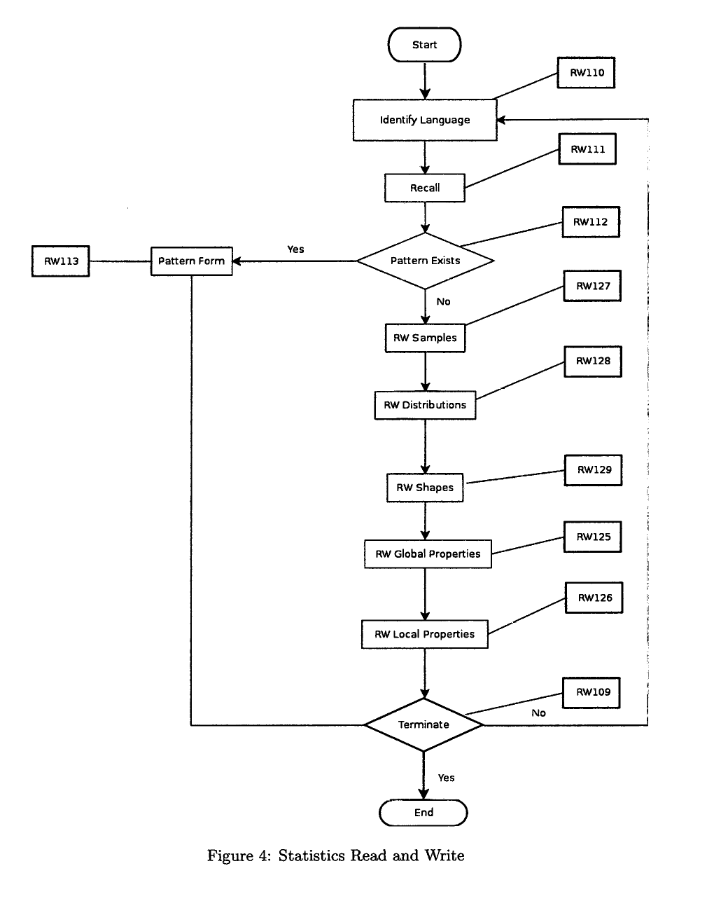

(38) FIG. 4 shows a flowchart in accordance with one embodiment of the invention. Initially, a request starts to read/write from a virtual space or a sensor. In one embodiment of the invention, read/write uses a language (RW110), recall (RW111), pattern exist determination (RW112), and pattern form (RW113) are specified in FIG. 2. In one embodiment of the invention, the RW samples (RW127) is invoked when the pattern is not detected. This invention develops the sampling with the selection and projection of subsets to estimate and approximate the characteristics of the whole spaces. This invention develops a frame with the property such that every single element can be identified and included any in the samples. In one embodiment of the invention, stratified sampling is developed when variability within strata are minimized or maximized. This invention develops stratified sampling when the variables upon which the population is stratified are strongly correlated with the desired dependent variable. Cluster are developed for sampling in other cases.

(39) In one embodiment of the invention, distributions (RW128) are developed as continuous probability distributions. This invention resembles the shapes (RW129) such as normal distribution in shape with different heavier tails as those in logistic distributions. This invention develops bell-shaped, S-shaped, and similar shapes with shape parameters. For example, this invention develops the mean and the variance as shape parameters. This invention develops a parametric family as a family of objects whose definitions depend on a set of parameters for functions, probability distributions, curves, shapes, etc.

(40) In one embodiment of the invention, the global properties are specified in RW125. The local properties are specified in RW126. A determination is made about whether read/write is terminated as specified in RW109.

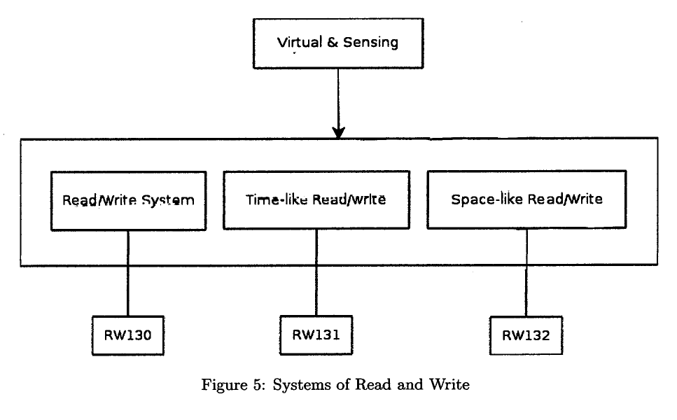

(41) FIG. 5 shows a system in accordance with one embodiment of the invention. In one embodiment of the invention, the read/write system (RW130) is specified in the above description of FIG. 1. Time-like read/write (RW131) is specified in the above description of FIG. 2. Space-like read/write (RW132) is specified in the above description of FIG. 3 and FIG. 4.

### REFERENCE

American Mathematics Competitions. Retrieved Apr. 31, 2016, from http://www.maa.org/math-competitions/about-amc
Read(process). In Wikipedia. Retrieved Apr. 31, 2016, from https://en.wikipedia.org/wiki/Reading_(process)
Write. In Wikipedia. Retrieved Apr. 31, 2016, from https://en.wikipedia.org/wiki/Writing

1) A method of read/write for computing comprising:
receiving a request to read/write from a virtual space and sensing environment;
determing a probe command associated with the request;
building a system of symbols and operational rules to identify the language;
recalling relevant instances with accuracy and measures;
identifying invariants as patterns for associated form processing;
enabling time like read/write or space like read/write.

2) The method of claim 1, further comprising:
processing the collected data on the management system to obtain processed data; and
displaying the processed data on the graphical user interface operatively connected to the management system

3) The method of claim 1, wherein the probe command comprise source code.

4) The method of claim 3, wherein determining the probe to enable comprise:
generating object code using the source code;
forwarding the object code to the tracing framework; and
analyzing the object code by the tracing framework to determine the probe to enable.

5) The method of claim 1, wherein building a system of symbols and operational rules to identify comprise:
determining read/write constants
determining read/write rationals
determining read/write sizes (big/small)
enabling scales of read/write
symbolizing read/write
constructing operational rules
constructing systems
determining iterations of read/write

6) The method of claim 5, wherein determining a constant comprise:
determining special and interesting objects and structures;
symbolizing the objects and structures with concise notations.
extracting analytic forms, letters, extra letters, and whole words.

7) The method of claim 5, wherein determining a rational comprise:
detecting the expansion with termination;
detecting the expansion with repeating the same finite sequence;
instrumenting a dense subset;
detecting a equivalence classes of ordered pairs.

8) The method of claim 5, wherein determining the size comprise:
collecting a collection of objects;
excluding the illegal “big of the big” as an object;
distinguishing the big and the small by a device.

9) The method of claim 8, wherein developing a device comprise:
Constructing universes;
Constructing a framework for both sets and classes;
Incorporating ad hoc devices with the framework of sets.

10) The method of claim 5, wherein determining the size also comprise:
Working exclusively with the small;
Mirroring the differences between the big and the small;
Keeping the track of the sizes;
Adding additional layers with the exposition of the above distinctions.

11) The method of claim 5, wherein determining the size comprise:
Ignoring the big;
Utilizing the above components when making arguments with the distinctions.

12) The method of claim 5, wherein enabling the scales comprise:
Expressing the big and the small by a form with a significant figure;
Adding to the precision with estimations;
Developing customary to record all figures with additional figures;
Conveying additional information about precision with notations;
Representing the final exact figures.

13) The method of claim 5, wherein enabling the scales comprise:
Executing a linear transformation;
Including the uniform scaling, the scaling with separate factor for each direction;
Including the non-uniform scaling with at least one of scaling factors;
Including the projections and reflections.

14) The method of claim 5, wherein symbolizing read/write comprise:
Organizing objects by types;
Organizing symbols by topics and subjects into tables;
Reserving some symbols;
Recognizing objects and structures without dependency of symbols.

15) The method of claim 5, wherein constructing operational rules comprise:
Performing mappings from inputs to the output;
Including nullary, unitary, binary, ternary, n-ary operations of different inputs;
Defining operations for any objects;
Focusing on inputs and outputs with operational rules;
Focusing on the process by operators.

16) The method of claim 5, wherein constructing systems comprise:
Enabling a system with the symbols and operational rules;
Enabling operators with determined processes;
Classifying symbols and operations into sets.

17) The method of claim 5, wherein determining iterations comprise:
determining the halt of output when arbitrary read/write as inputs are given;
Excluding the assumptions on the limits of resources;
Invoking an exit call to stop running;
Handling a child process when parent processes are dead;
Developing read/write table in consistent states;
Developing metrics, utilities, and goals for the criteria.

18) The method of claim 1, wherein recalling relevant instances comprise:
Developing binary classification for obtaining relevance;
Assigning scores to the relevance retrieved;
Plotting ROC curves;
Combining recall and accuracy;
Renormalizing and computing geometric means and measures.

19) The method of claim 1, wherein identifying invariants as patterns comprise:
Recognizing the equivalence of objects and structures;
Developing the algorithm for the recognition;
Recognizing standard forms and deformable objects;
Applying algebraic tools to analyze properties;
Identifying algebraic invariants;
Providing global information about the read/write;
Complementing local information of the read/write.

20) The method of claim 1, wherein enabling time like read/write comprise:
Determining explicit types, functions, relations for read/write;
Determining simultaneous functions and relations;
Invoking the system form for simultaneous functions and relations;
Determining recursive relations;
Invoking the recursion form as the process of repeating items;

21) The method of claim 20, wherein determining a explicit types comprise:
Identifying concrete objects, structures, and spaces;
Invoking the explicit form for explicit types, functions, relations;
Choosing an object, a morphism, subobject for each relation;
Developing an interpretation for each term;
Defining an interpretation of every logical formula;
Forming a building blocks of logical formula;
Interpreting existential and universal quantifiers;
Constructing a model with the objects, morphisms, and subobjects for the types.

22) The method of claim 20, wherein determining simultaneous relations comprise:
Constructing a map of unknown relations;
Simultaneously keeping track of read/write positions;
Developing the structural form in the vector form;
Post-multiplying the structure and writing the reduced form;
Deductive reasoning to obtain the structural form;
Developing topological map as a method of capturing the connectivity;

23) The method of claim 20, wherein determining the recursive read/write comprise:
Identifying base cases;
Terminating the scenario without the rules;
Identifying the subsequent term derived from the base;
Invoking recursion form as repeating items in a self-similar way;
Generalizing the recursion form as a process of repeating objects in a self-similar way.

24) The method of claim 20, wherein the sequential form is invoked when data are delivered in a sequence and are taken the position as the input.

25) The method of claim 1, wherein enabling space like read/write comprise:
Determining motions for read/write;
Determining inertia for read/write;
Invoking the system form for functions and relations;
Invoking the geometric form for functions and relations;
Identifying samples for read/write;
Identifying distributions and shapes for read/write;
Determining global and local properties;

26) The method of claim 25, wherein determining a motion comprise:
Preserving a metric;
Mapping congruent figures;
Preserving orientations;
Inverting orientations;
Invoking the geometric form with the trajectory of the motion;
Forming a group under compositions;

27) The method of claim 25, wherein determining a inertia comprise:
Detecting inertia with very large scales;
Interchanging energy and mass;
Determining long term behavior of the solutions;
Detecting finite-dimensional, smooth, and invariant manifolds;
Invoking the geometric form with the detection of the inertia;
Invoking the system form for the specified inertia;

28) The method of claim 25, wherein sampling comprise:
Constructing the selection and projection of subsets;
Estimating and approximating the whole spaces;
Developing a frame including every element;
Combining stratified sampling with clustering.

29) The method of claim 25, wherein distribution comprise:
Developing continuous probability distributions;
Specifying shape parameters;
Resembling the shape of the distributions;
Developing parametric families.

30) The method of claim 25, where in identifying global and local properties comprise:
Developing global properties such as continuity, homotopy groups etc;
Developing nonabelian local-to-global properties through algebraic inverse to subdivision;
Developing commutative cubes and cubical groups with connections;
Developing infinitesimal similarities which are not global similarities;
Composing inversions;
Developing functors and germs of objects.
